(19) United States
(12) Patent Application Publication
(10) Pub. No.: US 2015/0294309 A1
(43) Pub. Date: Oct. 15, 2015

(54) Method, Device and Service Provision Unit for Authenticating a Customer for a Service to be Provided by the Service Provision Unit

(71) Applicant: SIEMENS AKTIENGESELLSCHAFT, München (DE)

(72) Inventors: Jens-Uwe Busser, Neubiberg (DE); Santiago Reinhard Suppan, Pentling (DE); Fabienne Waidelich, Munchen (DE)

(21) Appl. No.: 14/646,671

(22) PCT Filed: Aug. 16, 2013
(86) PCT No.: PCT/EP2013/067164

§ 371 Date: May 21, 2015

(30) Foreign Application Priority Data
Nov. 21, 2012 (DE) 10 2012 221 288.4

(51) Int. Cl. G06Q 20/38; G06Q 50/06; G06Q 20/14

(52) U.S. Cl. CPC G06Q 20/3829; G06Q 20/145; G06Q 50/06; G06Q 2220/00

(57) ABSTRACT

Method, device and service provision means for authenticating a customer for a service to be provided by a service provision means. The invention relates to a method for authenticating a customer for a service to be provided by a service provision means. The method comprises the steps of: authentication of a customer as member of a defined customer group on the service provision means by means of a first group signature assigned to the defined customer to prove authorization of the customer to avail himself of a service; request for the service from the service provision means by the authenticated customer; and authentication of the customer as a member of the defined customer group by means of a second group signature assigned to the defined customer group to demonstrate the customer's consent to a billing process for billing the requested service at the billing centre. The method allows for a secure use of the service while assuring the customer's anonymity. The invention further relates to a device for performing the method and a service provision means.

This application is the National Stage of International Application No. PCT/EP2013/067164, filed Aug. 16, 2013, which claims the benefit of German Patent Application No. DE 10 2012 221 288.4, filed Nov. 21, 2012. The entire contents of these documents are hereby incorporated herein by reference.

### BACKGROUND

The present embodiments relate to authenticating a customer for a service to be provided by a service provision unit.

The term smart grid denotes a modern electricity grid including communicative networking and control of electricity generators, energy stores, electrical consumers and grid operating equipment.

One prerequisite for electromobility using electric vehicles (e.g., e-cars) is the presence of an extensive charging infrastructure. The charging of electric vehicles from the smart grid is to be linked in terms of information technology and communication technology with the personal data, deserving of protection, of a user or customer (e.g., vehicle owner or vehicle driver) for billing purposes. The additional communication and information infrastructure of the charging posts makes it possible to offer additional added value services and service facilities to the customer. These also require and generate personal data.

Charging posts and service providers are to communicate via third-party infrastructures in a method similar to roaming (e.g., in the case of the charging of the electric vehicle of a customer who is in a supply relationship with a first utility company via a charging post of a second utility company). As a result, sensitive personal data is distributed even further.

The electric vehicle, the driver or the customer, the charging post, and one or more service providers thus have to communicate with one another. The information generated and exchanged in this context allows insights into the private sphere of the vehicle users. For example, such data may be linked to form a personal profile.

A similar problem arises in the case of the shared use of the vehicles, referred to as carsharing.

The sequence for the use of carsharing is as follows. After persons interested in carsharing have entered into an agreement with a carsharing organization, the persons may reserve the desired vehicle, for example, by telephone or over the Internet using a browser or application (app) on a smartphone. In the case of some carsharing organizations, reservation may also be dispensed with, and a vehicle may be used spontaneously.

In the traditional carsharing model, the customer then takes the automobile key from a vault or opens the door of the vehicle with the aid of an electronic token and drives away. The carsharing organization solely attends to the technical maintenance or official formalities. The legal framework is regulated in the agreement between the carsharing organization and the customer.

Many carsharing organizations equip their vehicles with on-board computers that enable communication with the carsharing control center, whether for the purpose of localizing the current location of the vehicle with the aid of GPS data, releasing the vehicle to a specific customer for the booked time, or for the purpose of carrying out billing based on the kilometers driven and the period of use.

Such systems are much more efficient than manual bookings and contribute to faster discovery of misuses. The information generated and exchanged in this context allows far reaching insights into the private sphere of the carsharing users: a combination of all the data yields a personal profile that may disclose daily habits, specific location and time data, sensitive billing data, and particular tendencies.

In both cases described, both in the case of the charging of an electric vehicle at a charging post and in the case of carsharing, a service is thus provided by a respective service provision device (e.g., by the charging post or by the rental vehicle). In this case, problems may occur with regard to the data protection of the data of the respective customer.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, improved secure use of a service provided by a service provision device is provided.

A method for authenticating a customer for a service to be provided by a service provision device is provided. The method includes authenticating a customer as member of a specific customer group on the service provision device using a first group signature assigned to the specific customer group to verify the authorization of the customer to utilize the service. The service is requested at the service provision device on the part of the authenticated customer. The customer authenticated as a member of the specific customer group using a second group signature assigned to the specific customer group to verify the customer's consent to a billing process for billing the requested service at a billing center.

In this case, the first group signature serves to verify the authentication of the customer to utilize a service. The second group signature serves to verify the customer's consent to a billing process for billing the requested service.

The method enables secure use of the service whilst preserving the anonymity of the customers.

The method is distinguished by proactive data protection and high legal certainty.

In addition, the reduced amount of required data relieves the burden on selected communication channels. As a result of this, the use of a corresponding service provision device becomes more cost-effective, more secure and more efficient.

Embodiments of the method involve providing the requested service on the part of the service provision device.

In this way, the customer may utilize a service while preserving the anonymity of the customer.

Further embodiments of the method involve billing the provided service on the part of the billing center.

In this way, the service utilized by the customer may be billed while preserving the anonymity of the customer.

Further embodiments of the method involve providing cryptographic keys for generating the first group signature and the second group signature for authenticating the customer as member of the specific customer group.

Providing cryptographic keys for generating the group signatures includes issuing corresponding private keys for each member of the group (e.g., for each customer). With one keyIssue-K key per member group, the service provider generates private keys keySS-Ki for each customer i depending on which of the customer groups the customer i belongs to.

In further embodiments, the cryptographic keys are provided in one of the following: an electric vehicle; a mobile terminal; an access smart card; a service provision device; or a backend of a service provider that provides the service.

A mobile terminal is a smartphone, for example. An access smart card is an electronic vehicle key for the electric vehicle, for example. The term backend denotes the software running on the server of a client server system.

Further embodiments involve providing cryptographic keys for generating a service provision device signature for authenticating the service provision device with respect to the customer, and authenticating the service provision device with respect to the customer using the provided service provision device signature to verify the authorization of the service provision device to provide the service.

The cryptographic keys may be provided, for example, by a public key infrastructure (PKI) using an asymmetrical method such as RSA.

In this way, the service provision device may also authenticate itself with respect to the customer. In this case, the cryptographic keys used include a digital certificate and an associated private key.

Further embodiments involve providing cryptographic keys for generating a third group signature for authenticating the service provision device as member of a specific service provision device group at a service provider, and authenticating the service provision device as member of the specific service provision device group with respect to the customer using the third group signature to verify the authorization of the service provision device to provide the service.

In this way, conclusions about individual customers may not be drawn through the use of a specific service provision device (e.g., in conjunction with a specific, regularly repeated time of day, some other regularly reused added value service or regularly repeated service parameters). By virtue of the fact that both the customer and the service provision device in each case provide a valid group signature, a provider of services may make services available without knowing the exact location of the service provision device or the identity of the enquiring customer. It is also not possible for other communication partners or a hacker to establish a personal link.

In further embodiments, the service provision device is embodied as a charging post for electric vehicles, and the service is electrically charging the electric vehicle or an added value service.

An added value service may be a service that supplements other services (e.g., the electrical charging) in order to increase the value or benefit of these services. One example of an added value service is the sale of a digital newspaper.

In further embodiments, the service provision device is embodied as a rental vehicle, and the service is renting out the rental vehicle.

In this way, a carsharing service that preserves the anonymity of the customer may, for example, be provided.

In further embodiments, a communication between the customer and the service provision device with regard to authenticating and/or requesting the service takes place via a cable connection, a wireless local area network connection, a Bluetooth connection, a near field communication connection, or a mobile radio connection.

Near field communication is a transmission standard for the contactless exchange of data over short distances of up to 4 cm. A mobile radio connection is a GSM connection, a UMTS connection or an LTE connection, for example.

In further embodiments, the communication between the customer and/or the service provision device and/or the billing center is encrypted by one of the following security protocols: Secure Sockets Layer (SSL); Transport Layer Security (TLS); Internet Protocol Security (IPSec).

Further security protocols may be used. By way of example, the use of the Advanced Encryption Standard (AES) in combination with an asymmetrical cryptographic method is advantageous in this case. This further increases the security of the method of one or more of the present embodiments.

In further embodiments, the billing of the requested service at the billing center is implemented with a prepaid method, a method for payment using a mobile terminal, or a debit method.

The various payment methods enable the provided service to be billed flexibly and conveniently for the customer.

In further embodiments, the specific customer group is assigned to a specific performance range and/or a specific tariff option at a service provider that provides the service.

A customer who has authenticated himself/herself as member of the specific customer group is authorized to utilize the requested service in the desired performance range and/or with regard to the desired conditions.

In further embodiments, the specific charging post group corresponds to a group of charging posts in a specific coverage area and/or of a specific model type.

In this way, groups of charging posts may be combined and anonymized with respect to the service provider in order to avoid derivation of personal data regarding the use behavior of a customer.

A device for authenticating a customer for a service to be provided by a service provision device is provided. The device includes a first device (e.g., a first unit or a processor) for authenticating a customer as member of a specific customer group on the service provision device using a first group signature assigned to the specific customer group to verify the authorization of the customer to utilize a service; a second device (e.g., a second unit or the processor) for requesting the service at the service provision device on the part of the authenticated customer; and a third device (e.g., a third unit or the processor) for authenticating the customer as member of the specific customer group using a second group signature assigned to the specific customer group to verify the customer's consent to a billing process for billing the requested service at the billing center.

The respective units, the first unit, the second unit, and the third unit, may be implemented in terms of hardware and/or in terms of software. In the case of a hardware implementation, the respective units may be embodied as a device or as part of a device (e.g., as a computer or as a microprocessor). In the case of a software implementation, the respective units may be embodied as a computer program product, as a function, or as a routine, as part of a program code or as an executable object.

A service provision device including a corresponding device is provided.

A computer program product that instigates the performance of at least one act of the method presented above on a program controlled apparatus is provided.

A computer program product such as a computer program device may be provided or supplied, for example, as a storage medium (e.g., a non-transitory computer-readable storage medium), such as a memory card, USB stick, CD-ROM, DVD, or else in the form of a downloadable file from a server in a network. This may be implemented, for example, in a wireless communication network by the transmission of a corresponding file with the computer program product or the computer program device.

A data carrier including a stored computer program including commands that instigate the performance of at least one act of a corresponding method on a program controlled apparatus is provided.

Further possible implementations encompass combinations, not mentioned explicitly, of method acts, features or embodiments of the method or of the arrangement as described above or below with respect to the exemplary embodiments. In this case, the person skilled in the art will also add or amend individual aspects as improvements or supplementations to the respective basic form of the invention.

### BRIEF DESCRIPTION OF THE DRAWINGS

FIG. 1 shows a schematic view of one exemplary embodiment of a device for authenticating a customer for a service provided by a service provision device;

FIG. 2 shows a schematic flowchart of one exemplary embodiment of a method for authenticating a customer for a service provided by a service provision device;

FIG. 3 shows a schematic flowchart of a first part of a further exemplary embodiment of the method for authenticating a customer for a service provided by a service provision device;

FIG. 4 shows a schematic flowchart of a second part of the further exemplary embodiment of the method;

FIG. 5 shows a schematic flowchart of a first part of a further exemplary embodiment of the method for authenticating a customer for a service provided by a service provision device; and

FIG. 6 shows a schematic flowchart of a second part of the further exemplary embodiment of the method.

### DETAILED DESCRIPTION

In the figures, same or functionally same elements have been provided with the same reference signs unless indicated otherwise.

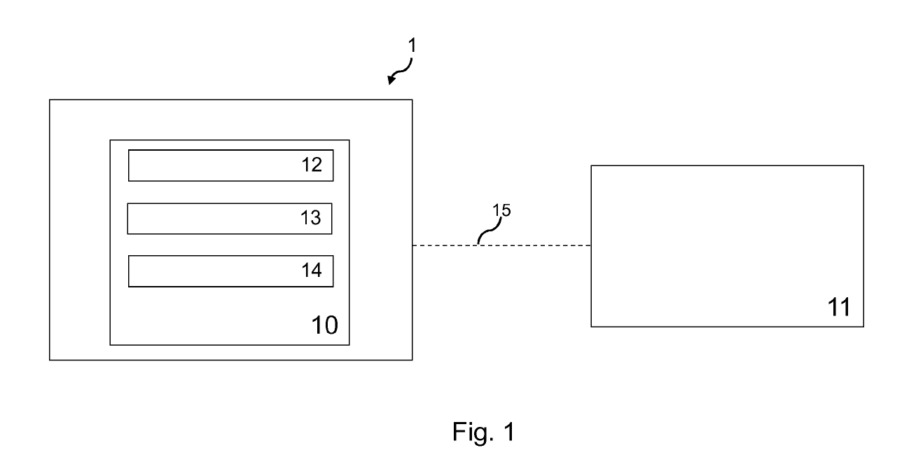

FIG. 1 shows a schematic view of one exemplary embodiment of a device for authenticating a customer for a service provided by a service provision device 1. In the case illustrated, the service provision device 1 is a charging post 1 for electric vehicles 11. In FIG. 1, the charging post 1 and the electric vehicle 11 are coupled by a charging cable 15, via which both charging current and communication data may be transported.

The device 10 includes a first unit 12 (e.g., a processor) for authenticating a customer as member of a specific customer group at the charging post 1 using a first group signature assigned to the specific customer group to verify the authorization of the customer to utilize a service. The device 10 also includes a second unit 13 (e.g., the processor) for requesting the service at the charging post 1 on the part of the authenticated customer, and a third unit 14 (e.g., the processor) for authenticating the customer as member of the specific customer group using a second group signature assigned to the specific customer group to verify the customer's consent to a billing process for billing the requested service at the billing center.

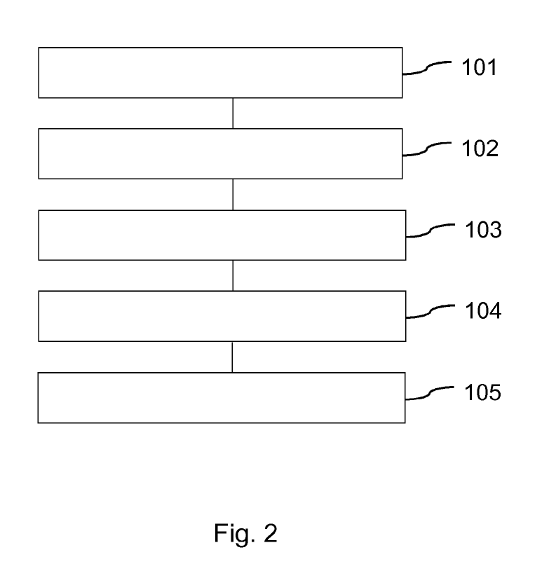

FIG. 2 shows a schematic flowchart of one exemplary embodiment of a method for authenticating a customer at a charging infrastructure for electric vehicles 11.

Act 101 involves authenticating a customer as member of a specific customer group at the charging post 1 using a first group signature assigned to the specific customer group to verify the authorization of the customer to utilize a service.

If the customer was unable to authenticate himself/herself correctly, the method is terminated at this point.

Act 102 involves requesting the service at the charging post 1 on the part of the authenticated customer.

Act 103 involves authenticating the customer as member of the specific customer group using a second group signature assigned to the specific customer group to verify the customer's consent to a billing process for billing the requested service at the billing center.

Act 104 involves providing the requested service on the part of the charging post 1 (e.g., charging the electric vehicle 11) or providing an added value service, or a combination of a plurality of services.

Act 105 involves billing the provided service on the part of the billing center.

A group signature such as is used in the proposed method enables each member of a group to sign a message as member of a group. Each member of the group has a dedicated private key and may thus generate a group signature. In this case, the respective member remains anonymous with respect to the recipient of the signed message. A verifier has a corresponding single public group key and may use the public group key to check the signature of a message generated by a group member. However, the verifier obtains no information regarding which member of the group has created the signature and thus the message. If the verifier obtains two signed messages, then the verifier is also unable to ascertain whether the messages were signed by two different members of the group or whether both messages were signed by the same member of the group.

A group signature method may include at least the following acts: 1. The function “GKg” generates three keys: keyOpen, keyIssue and keyVerify; 2. The key keyIssue is transferred to an authority having the function “Join”, which dynamically creates private keys for members of a group (keyS-Si) from keyIssue; a new member may sign arbitrary messages “m” in the name of the group: sig(m)g; 3. The function “GVrfy” checks the group membership of the signature creator i with the aid of keyVerify, m, sig(m)g; if membership is confirmed, then a resource may be released for the signature creator i; and 4. If there is a case of dispute, then a further authority, different than the authority mentioned under point 2, may assign a signature sig( ) to a member i using the function “open”; for this purpose, keyOpen, sig(m)g and m are used.

An exemplary implementation of a group signature method may be found in D. Boneh et al., Short group signatures, in: Volume 3152 of Lecture Notes in Computer Science, pages 41-55, Springer-Verlag.

Hereinafter, reference is made to the above group signature method and its use based on the example of the charging infrastructure.

The following concentrates on the best possible data protection. Deviations therefrom in the areas of the information actually signed (e.g., signatures of the prices, of the desired state of charge, etc.), of the communication technology used (e.g., cable, WLAN, Bluetooth, GSM, UMTS, LTE, etc.), communication encryptions (e.g., SSL/TLS, IPSec, AES, RSA, ECC, etc.), use components (e.g., mobile terminals/smartphones, vehicles, smart cards, vehicle keys, etc.), payment methods (e.g., prepaid, mobile payment, debit, etc.) and the implementation thereof (e.g., directly at the service provider, via a third party, via a financial institution, etc.) may be provided.

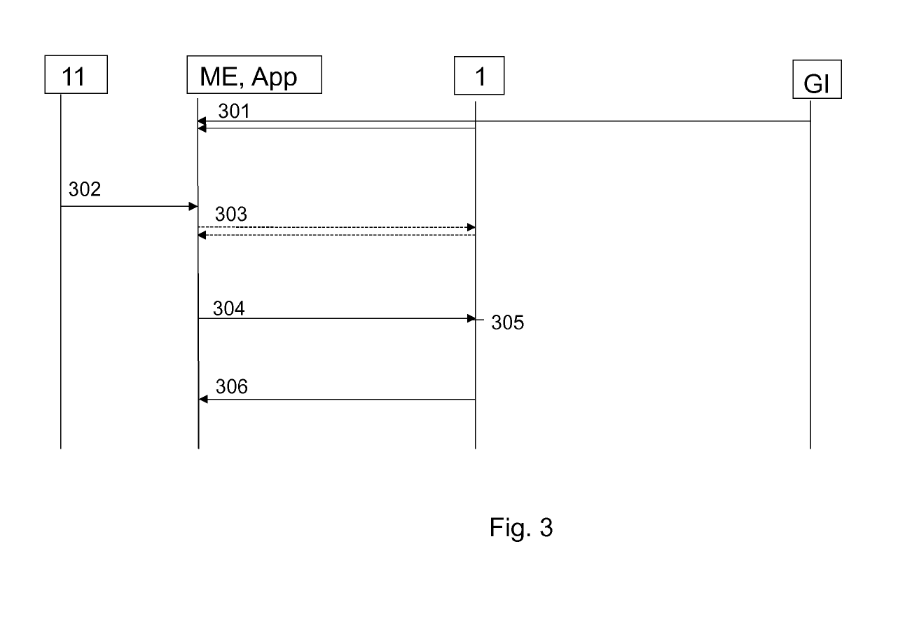

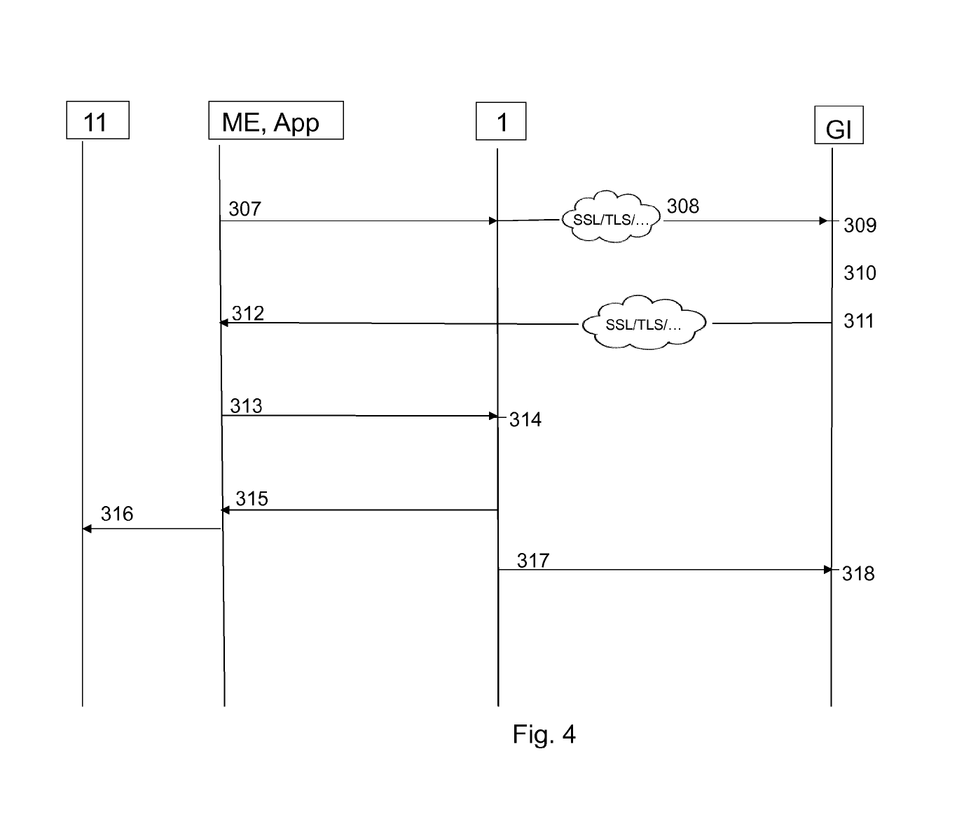

The following explains the method of one or more of the present embodiments in detail with reference to FIGS. 3 and 4. FIG. 3 illustrates a first part of the method, and FIG. 4 illustrates a corresponding second part of the method.

In this example, an energy supplier is the provider of a charging infrastructure without the involvement of the vehicle manufacturer.

The communication illustrated in FIG. 3 takes place, for example, using a mobile terminal ME and near field communication with the charging post 1 and the vehicle 11. In this way, added value services may be obtained via the mobile terminal ME.

Alternatively, the corresponding functionality of the mobile terminal ME may also be integrated into the vehicle or the vehicle key, for example.

An additional assumption is that all connections may be appropriately encrypted.

In one embodiment, the financial institution GI involved for billing the provided service may be a billing center for the energy supplier.

In the present scenario, all of the keys, keyOpen, keyIssue and keyVerify, are generated by an independent service provider, keyOpen-K, keyIssue-K and keyVerify-K, for authenticating the customer, keyOpen-KPayment, keyIssue-KPayment and keyVerify-KPayment, for payment and keyOpen-LS, keyIssue-LS and keyVerify-LS for the charging post. Afterward, keyIssue-K, keyIssue-LS, keyIssue-KPayment, keyVerify-K, keyVerify-LS and keyVerify-KPayment are communicated securely to the energy supplier.

The group signature method may be replaced by a digital signature method at the charging posts, for example, if the energy supplier is to know the locations of the charging posts and implementations of the charging posts.

All three keyOpen keys are stored securely, and the first two are used only in justified situations. It is therefore advantageous to have these first two keys generated and stored by an independent service provider.

Both keys keyOpen-LS and keyOpen-K remain in the possession of the independent service provider. Both keys are only used to clarify disputed incidents. The key keyOpen-KPayment is acquired by the financial institution for determining the identity of a customer in the context of payment for a provided service.

A member group includes customers who have booked a specific performance range and/or a tariff option. A charging post group corresponds, for example, to a group of charging posts of a relatively large coverage area or model type.

With one keyIssue-K key and one keyIssue-KPayment key per member group, the energy supplier generates private keys keySS-Ki and keySS-KPaymenti for each customer i depending on which of the groups the customer i belongs to. These keys are stored, for example, by an application App in the mobile terminal ME. The keys keyIssue-K and keyIssue-KPayment remain in the closed disposition domain of the energy supplier. The keyVerify-K key and the keyVerify-KPayment key are embedded into the charging post 1 as required in each case or kept available in the implementing backend of the energy supplier.

The creation of the group signature by the customer with the key keySS-Ki to verify the authorization of the customer firstly to utilize a service and secondly for a billing process for billing the requested service and the creation of the group signature by the customer with the key keySS-KPaymenti for billing allows a clean separation between, firstly, authentication of the customer and ordering of the service and, secondly, confirmation of the billing to be performed. In this case, the financial institution may only open the group signatures that were generated with the key keySS-KPaymenti, and thus obtains only the billing-relevant information, but no information about the service ordered. If this separation is dispensed with, then a single group key is sufficient for the customer. The keys K and KPayment are then identical.

With one keyIssue-LS key per charging post group, the energy supplier generates private keys keySS-LSj for each charging post j depending on which of the groups the charging post j belongs to. These keys are stored in the charging post j, for example. The keyIssue-LS key remains in the closed disposition domain of the energy supplier. The key-Verify-LS key is made available to the customer upon having entered into an agreement or later by the backend.

Since a single keyVerify key suffices for checking all customers of a group (e.g., tariff), all checking keys of each charging post 1 in each case may be stored and periodically updated. This procedure is recommendable, for example, if the charging post 1 communicates with the backend only irregularly (e.g., once a day).

If the charging post 1 communicates with the backend upon every use by a customer, it is recommendable for the keyVerify keys to be kept available in the backend of the energy supplier.

As illustrated in FIG. 3, a preparatory act 301 involves adapting the mobile terminal ME to the charging infrastructure (e.g., by downloading and installing an application App).

If a customer would then like to charge the electric vehicle 11, the customer connects the electric vehicle to the charging post 1 in act 302. In parallel therewith, the mobile terminal ME (e.g., the customer's smartphone) connects to the charging infrastructure by NFC, WLAN, Bluetooth or the like in act 302. The battery state of the electric vehicle 11 is transmitted to the application App in act 302.

In act 303, the charging post 1 sends a challenge message with a random number to the smartphone and waits for a valid group signature of the customer as response. This first challenge may be linked with a digital signature of the charging post 1 by a private PKI key assigned to the charging post or with a group signature of the charging post 1 in order to authenticate the charging post 1 with respect to the application App and the customer. In this way, the mutual authentication of the charging post 1 and the customer takes place in act 303.

If this signature of the charging post 1 is valid and if the customer has likewise supplied a valid group signature, there follows a session-based encryption between the charging post 1 and the smartphone (e.g., by a secure connection based on the transport layer security protocol).

After successful mutual authentication, the customer enters the desired charging time and/or the desired battery filling level. The customer signs this desire, paired again with a random number (“salt”) and a specific time indication (timestamp, “t1”), and this produces the message 1 (“m1”) and the first group signature 1 (“s1(m1)g”). This message is communicated to the charging post 1 by the application App in act 304.

Act 305 involves a signature check being carried out by the charging post 1. In this way, the charging post 1 determines the customer's tariff group and may indicate the price per kW/h and calculate the anticipated total price.

The charging post 1 signs over the original message “m1”, “s1” and the price indication with a charging post signature and appends the original group signature “s1” of the customer. This produces the message “m2” with the second group signature “s2(m2)g”. This message is communicated to the application App by the charging post 1 in act 306.

If an integrity-protected connection, authenticated on both sides, between smartphone and charging post 1 is set up as described for act 303, then it is not necessary to provide the messages “m1” and “m2” with (group) signatures. If the messages “m1” and “m2” are protected with signatures (e.g., group signatures), then the authentication on both sides may be dispensed with in act 303.

The further acts of the method will be explained with reference to FIG. 4.

In act 307, the application App checks the validity of the new signature “s2” over the message “m2”. If this is valid, the customer may authorize the price.

While the previous communication steps may proceed in an automated manner, the authorization or confirmation of the price may additionally be carried out by the customer manually by entering a PIN, providing a fingerprint or the like in act 307 in order to further increase the security of the method.

In addition, a new message “m3” is signed in act 307. “m3” includes “m1”, “m2”, a billing token “at” and, if appropriate, a new timestamp. “at” designates a placeholder containing information for the later remuneration of the energy service provider (e.g., a prepaid card code or a token that authenticates the energy provider for debiting an amount from the customer's bank account).

The signature “s3(m1, m2, s1, s2, at)g” is appended. This is regarded as confirmation of the current price. The group signature “s3” and the message “m3” thus contain indications about the originally desired performance range, the confirmation thereof by the service provider, the proposed price thereof and the final confirmation by the customer. The corresponding message is communicated to the charging post 1 by the application App and concludes act 307.

All indications are demonstrable with legal validity by signatures and timestamps since both the customer and the charging post 1 may be determined as necessary by the “opening” of the group signatures by the independent service provider.

Up to this point in time, all transactions proceed without knowledge of the identity of the participants.

For the further procedure of payment with regard to the billing of the provided service in cooperation with the financial institution GI, it is to be decided how a customer would like to pay for the services utilized. Possible variants include: 1) The customer has a flat rate tariff; 2) The customer uses a prepaid solution; and 3) The customer uses a mobile payment system or a debit method for the energy supplier or a financial institution cooperating with the energy supplier.

In case 1), the mutual authentication is sufficient. The validity of the group signature provides the customer's membership of the paying customer group having the “flat rate” tariff. The billing token “at” in “m3” may thus be omitted.

Act 105 is then obviated.

In case 2), the energy provider cooperates with providers of prepaid payment systems. In this case, a billing token is added to the message “m3” and signed. The billing token is stored with an amount and may be debited by the payment provider without any further personal link. In this case, the customer may utilize services only up to the maximum amount of the billing token.

In case 3), the billing token is created on the part of the financial institution GI (or the mobile payment system), as illustrated in FIG. 4.

The charging post 1 checks and confirms “s3” and “m3” in act 308. In act 308, the mobile terminal ME with the keySS-KPaymenti key with a group signature and the charging post 1 sign a total sum indication (“s4”+“m4”), which the financial institution GI is intended to receive. In this regard, the financial institution GI does not know any price-related tariff details, but rather is informed only of the final amount to be billed for the provided service.

In act 309, the cooperating financial institution GI may then check the validity of “s4” by the keyVerify key of the charging post 1 in order to confirm the participation of the energy supplier partner and thus the enquiring charging post 1.

In act 310, the financial institution GI verifies using its own keyVerify key, which represents the counterpart with respect to the keySSi-KPayment keys, the customer group to which the customer belongs. If the validity may be confirmed, this provides that the customer has manually confirmed previous transactions with the partner by the PIN entry, otherwise “s3” and/or “s4” would not have been created.

In act 310, the financial institution GI identifies the original creator (e.g., the customer) by cancelling the anonymity of the signature with the keyOpen-KPayment. The group signature method with the aid of the “-KPayment key” acts as pseudonymization with the advantage that no pseudonymous assignment tables have to be managed, and pseudonyms do not have to be renewed in order to avoid concatenations of data and thus the derivation of personal profiles.

The steps illustrated make it possible that only the financial institution GI may identify the respective customer. The financial institution GI then knows indications about the price of the provided service and the customer, but the financial institution GI does not know the purpose of the service and the implementation location.

In act 311, the financial institution GI creates a shadow account n1 for the customer for the period of validity in a manner similar to the prepaid method. The shadow account is stored with the sum from “m4”.

In act 312, a corresponding identifier number “n1” is added to a response message, signed and sent to the mobile terminal ME.

In act 313, the mobile terminal ME sends a message a1 with a billing token “at” to the charging post 1. In this case, “at” contains the shadow account number “n1”. If the service requested by the customer (e.g., the charging of the electric vehicle 11) ends successfully, the service provider or the charging post 1, after an authentication by “n1”, may request and debit the corresponding amount from the financial institution GI.

In act 314, the message a1 is temporarily stored in the charging post 1. This serves for legal proof of the transaction carried out. In this case, the message a1 has no personal link whatsoever. The shadow account number “n1” is stored. At the end of the day, billing of all services provided by the charging post 1 may, for example, be carried out, and the corresponding amounts may be requested with indication of the stored shadow account numbers at the financial institution GI.

In act 315, the charging confirmation is sent from the charging post 1 to the application App to confirm the requested charging process for the quantity of electricity or charging time requested by the customer for the price previously confirmed by the customer.

In act 316, the electric vehicle 11 is charged until the desired charging time or the desired quantity of electricity is reached.

For final billing of the service provided by the charging post 1, in act 317, a message is sent from the charging post 1 to the financial institution GI with indication of the price for the quantity of electricity desired by the customer and the shadow account number “n1”. This message is signed by the charging post 1 with a corresponding group signature.

In act 318, the group signature of the charging post 1 is checked by the financial institution GI. After successful checking, the requested amount is transferred from the shadow account “n1”. At the same time, the amount is requested by debit from the customer's account.

The shadow account may then be deleted, and the shadow account number “n1” may be released again.

If the customer terminates the charging process prematurely, a termination protocol is started. The termination protocol contains a termination instruction and the shadow account number “n1”. A residual credit that has remained in the shadow account “n1” may be stored until the next charging process.

Alternatively, the shadow account may be temporally limited for individual transactions. Accordingly, in the event of termination, the residual credit is deducted from an associated debit calculation, and the shadow account is canceled again near-instantaneously.

The method thus enables a charging and payment process that is completely anonymous outside the financial institution GI.

With the use of additional added value services, the acts illustrated in FIG. 4 are correspondingly performed repeatedly for each added value service.

The proposed method contributes, by virtue of the increased data protection of the personal data of customers of a charging infrastructure for electric vehicles, to increasing user acceptance and thus the implementability and sustainability of the e-car charging infrastructure.

The method makes it possible to protect personal customer data by allowing customers, depending on the payment system, to obtain electrical energy for charging electric vehicles and also further services at a charging post, without revealing their identity to the charging post. At the same time, it is possible to bill the services obtained without the financial institution that performs the billing obtaining information about the services utilized by the customer.

The method prevents the creation of personal profiles that may disclose daily habits, specific location and time data, sensitive billing data and particular tendencies depending on the range of added value services or by tracking the charging station locations.

The method may be used flexibly in resource-limited systems such as mobile terminals, vehicles or smart cards. An efficient implementation is possible, for example, by the use of elliptic curve cryptography (ECC).

This method thus represents a solid basis for transmitting critical information flows in the smart grid.

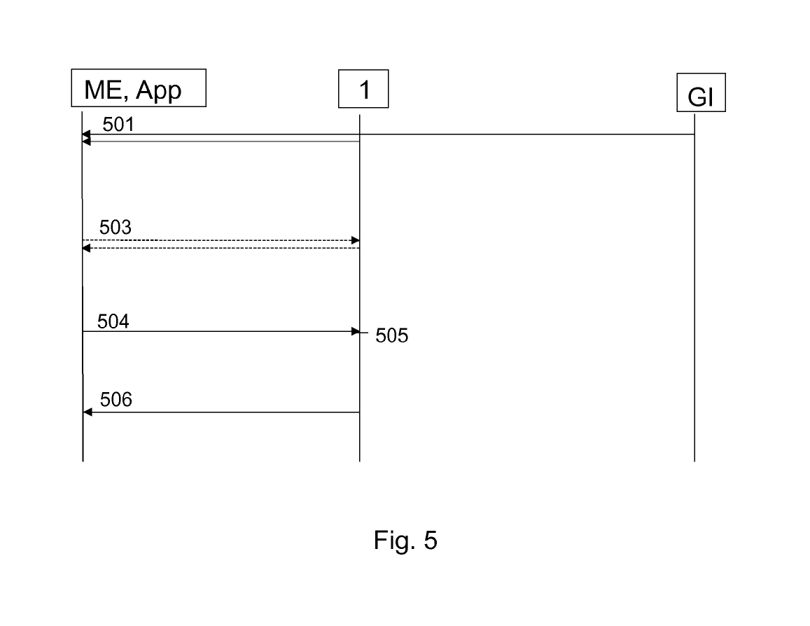

FIG. 5 shows a schematic flowchart of a first part of a further exemplary embodiment of the method for authenticating a customer for a service provided by a service provision device. In the case illustrated, the service provision device 1 is embodied as a rental vehicle 1, and the service is renting out the rental vehicle 1 in the context of a carsharing service provided by a service provider.

When mention is made hereinafter of acts performed by the rental vehicle 1, this should be understood to provide that either the rental vehicle 1 performs these acts, for example, using an on-board computer, or that the carsharing service provider performs these acts. It is also possible for the relevant acts to be performed jointly by the rental vehicle 1 and the service provider or with cooperation of the rental vehicle 1 and the service provider.

As illustrated in FIG. 5, a preparatory act 501 involves adapting the mobile terminal ME in order to enable carsharing for the customer (e.g., by downloading and installing an application App).

In act 503, the rental vehicle 1 sends, for example, using the on-board computer, a challenge message with a random number to the smartphone and waits for a valid group signature of the customer as response. This first challenge may be linked with a digital signature of the rental vehicle 1 using a private PKI key assigned to the rental vehicle or with a group signature of the rental vehicle 1 in order to authenticate the rental vehicle 1 with respect to the application App and the customer. In this way, the mutual authentication of the rental vehicle 1 and the customer takes place in act 503.

If this signature of the rental vehicle 1 is valid and if the customer has likewise supplied a valid group signature, there follows a session-based encryption between the rental vehicle 1 and the smartphone (e.g., using a secure connection based on the transport layer security protocol).

After successful mutual authentication, the customer enters the desired duration and/or the desired range of the rental process, for example. The customer signs this desire, paired again with a random number (e.g., “salt”) and a specific time indication (e.g., timestamp, “t1”), and this produces the message 1 (e.g., “m1”) and the first group signature 1 (e.g., “s1(m1)g”). This message is communicated to the rental vehicle 1 by the application App in act 504.

Act 505 involves a signature check being carried out by the rental vehicle 1. In this way, the rental vehicle 1 determines the customer's tariff group and may determine the price per kilometer driven and calculate the anticipated total price.

The rental vehicle 1 signs over the original message “m1”, “s1” and the price indication with a rental vehicle signature and appends the original group signature “s1” of the customer. This produces the message “m2” with the second group signature “s2(m2)g”. This message is communicated to the application App by the rental vehicle 1 in act 506.

If an integrity-protected connection, authenticated on both sides, between the application App on the smartphone and the rental vehicle 1 is set up as described for act 503, then it is not necessary to provide the messages “m1” and “m2” with (group) signatures. If the messages “m1” and “m2” are protected with (group) signatures, then the authentication on both sides may be dispensed with in act 503.

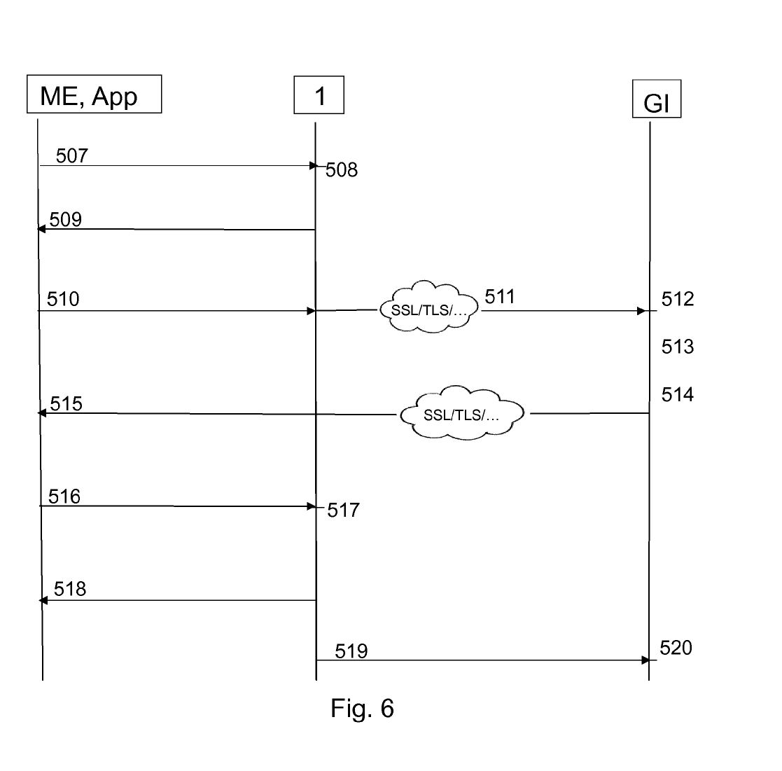

The further acts of the method will be explained with reference to FIG. 6.

In act 507, the application App checks the validity of the new signature “s2” over the message “m2”. If this is valid, the customer may authorize the price. The customer signs this price, paired again with a random number (e.g., “salt”) and a specific time indication (e.g., timestamp, “t1”), and this produces message 3 (e.g., “m3”) and group signature (e.g., “s3(m3)g”). This message is likewise communicated to the rental vehicle 1 in act 507.

In act 508, the rental vehicle 1 checks the customer's signature. If the customer's signature is valid, then the customer has confirmed the offered price. The rental vehicle 1 may then be started.

After the end of the journey, in act 509, the total price is calculated by the rental vehicle 1 or by the service provider, and the customer is requested to pay the total price. For this purpose, the rental vehicle 1 generates a signature (s4) over the total price, a timestamp and the previous confirmation (s3+m3) of the customer (=message m4). This message is sent from the rental vehicle 1 to the application App on the customer's smartphone in act 509.

In act 510, after checking s4 over m4, the customer confirms the price. A new message “m5” then is to be signed. “m5” includes “m3”, “m4”, a billing token “at” and, if appropriate, a new timestamp. “at” designates a placeholder containing information for the later remuneration of the carsharing service provider (e.g., a prepaid card code or a carsharing token that authenticates the service provider for debiting an amount from the customer's bank account). The message m5 is sent from the application App to the rental vehicle 1 in act 510.

The signature “s5(m4,m3,s4,s3,at)g” is appended to the message m5. This is regarded as confirmation of the current price. The signature “s5” and the message “m5” thus contain indications about the originally desired performance range, the confirmation thereof by the service provider, the proposed price thereof, and the final confirmation by the customer. All these indications are demonstrable with legal validity by signatures and timestamps since both the customer and the service provider and the rental vehicle may be determined as necessary. Up to this point in time, all transactions proceed without knowledge of the identity of the participants.

This final message m5 is used for billing the rental process on the part of the financial institution GI in the further course of the method. The final message m5 serves as proof to the service provider that the service provider has provided the service described therein at the indicated price for the customer. The final message m5 simultaneously serves as proof to the customer that the customer has properly handed back the rental vehicle 1 again (e.g., has parked the rental vehicle 1) at a predetermined or arbitrary location.

As a result of this message m5 being sent in act 510, the rental vehicle is locked until a next customer rents the rental vehicle 1 again. If locking is not possible (e.g., because the doors have not been properly closed), then the customer receives a corresponding indication. If locking repeatedly fails, then the customer is requested to contact the service department of the service provider, or the service department receives an automated fault message.

The customer's group signatures are created by the customer's smartphone or a similar device. The customer's smartphone, for example, at least in messages m3 and m5, for legal and security reasons, may request the customer to enter a PIN, to provide a fingerprint at a sensor provided for this purpose, or something similar. By contrast, the group signatures for the messages m1 and also for m2 and m4 are generated by the smartphone and respectively by the rental vehicle 1 in an automated manner (e.g., without manual user action).

For the further procedure of payment with regard to the billing of the provided service in cooperation with the financial institution GI, it is to be decided how a customer would like to pay for the services utilized. Possible variants include: 1) The customer has a flat rate tariff; 2) The customer uses a prepaid solution; 3) The customer uses a mobile payment system or a debit method for the carsharing provider or a financial institution cooperating with the carsharing provider.

In case 1), the mutual authentication is sufficient. The validity of the group signature provides the customer's membership of the paying customer group having the “flat rate” tariff. The billing token “at” in “m5” may thus be omitted.

In case 2), the energy provider cooperates with providers of prepaid payment systems. In this case, a billing token is added to the message “m5” and signed. The billing token is stored with an amount and may be debited by the payment provider without any further personal link. In this case, the customer may utilize services only up to the maximum amount of the billing token.

In case 3), the billing token is created on the part of the financial institution GI (or the mobile payment system), as illustrated in FIG. 6:

In act 511, m5 and s5 are forwarded to the financial institution GI without the billing token at.

In act 512, the cooperating financial institution GI checks the validity of “s5” using the keyVerify key of the carsharing operator in order to confirm the participation of the operator as a partner. The financial institution GI may likewise verify the customer group using its own keyVerify key, which represents the counterpart with respect to the keySSi-KPayment keys. If the validity may be confirmed, then the customer has properly confirmed previous transactions with the partner. Otherwise, “s5” would not have been created.

The financial institution GI is to be able to identify the customer participating in the method. The financial institution GI thus knows indications about the price and the customer, but not the purpose of the service and the implementation location.

In act 513, the financial institution GI identifies the original creator (e.g., the customer) by canceling the anonymity of the signature with the keyOpen-KPayment. The group signature method with the aid of the “-KPayment key” acts as pseudonymization with the advantage that no pseudonymous assignment tables have to be managed, and pseudonyms do not have to be renewed in order to avoid concatenations of data and thus the derivation of personal profiles.

In act 514, the financial institution GI creates a shadow account n1 for the customer for the period of validity in a manner similar to the prepaid method. The shadow account is stored with the sum from “m4”.

In act 515, a corresponding identifier number “n1” is added to a response message, signed and sent to the mobile terminal ME.

In act 516, the mobile terminal ME sends a message a1 with a billing token “at” to the rental vehicle 1. In this case, “at” contains the shadow account number “n1”. The carsharing service provider, after an authentication by “n1”, may thus request and debit the corresponding amount from the financial institution GI.

In act 517, the message a1 is temporarily stored in the rental vehicle 1 or at the carsharing provider. This serves for legal proof of the transaction carried out. In this case, the message a1 has no personal link. The shadow account number “n1” is stored. It is thus possible, for example, at the end of the day, to carry out billing of all services provided by the rental vehicle 1 and to request the corresponding amounts with indication of the stored shadow account numbers at the financial institution GI.

In act 518, the remuneration confirmation is sent from the rental vehicle 1 to the application App to confirm the service requested by the customer for the price previously confirmed by the customer.

For final billing of the service provided by the rental vehicle 1, in act 519, a message is sent from the rental vehicle 1 to the financial institution GI with indication of the price for the rental duration desired by the customer or the kilometers driven and the shadow account number “n1”. This message is signed by the rental vehicle 1 with a corresponding group signature.

In act 520, the group signature of the rental vehicle 1 is checked by the financial institution GI. After successful checking, the requested amount is transferred from the shadow account “n1”. At the same time, the amount is requested by debit from the customer's account.

The shadow account may then be deleted, and the shadow account number “n1” may be released again.

The method thus enables a process of renting a rental vehicle of a carsharing provider that is completely anonymous outside the financial institution GI.

Although the invention has been more specifically illustrated and described in detail by the exemplary embodiments, the invention is not restricted by the examples disclosed. Other variations may be derived therefrom by the person skilled in the art without departing from the scope of protection of the invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for authenticating a customer for a service to be provided by a service provision device, the method comprising:
authenticating, by a processor, a customer as member of a specific customer group on the service provision device using a first group signature assigned to the specific customer group to verify authorization of the customer to utilize the service;
requesting the service at the service provision device on the part of the authenticated customer; and
authenticating the customer as member of the specific customer group using a second group signature assigned to the specific customer group to verify consent of the customer to a billing process for billing the requested service at a billing center.

2. The method of claim 1, further comprising:
providing the requested service on the part of the service provision device.

3. The method of claim 2, further comprising:
billing the provided service on the part of the billing center.

4. The method of claim 1, further comprising:
providing cryptographic keys for generating the first group signature and the second group signature for authenticating the customer as member of the specific customer group.

5. The method of claim 4, wherein the cryptographic keys are provided in an electric vehicle, a mobile terminal, an access smart card, the service provision device, or a backend of a service provider that provides the service.

6. The method of claim 1, further comprising:
providing cryptographic keys for generating a service provision device signature for authenticating the service provision device with respect to the customer; and
authenticating the service provision device with respect to the customer using the provided service provision device signature to verify the authorization of the service provision device to provide the service.

7. The method of claim 1, further comprising:
providing cryptographic keys for generating a third group signature for authenticating the service provision device as member of a specific service provision device group at a service provider; and
authenticating the service provision device as member of the specific service provision device group with respect to the customer using the third group signature to verify the authorization of the service provision device to provide the service.

8. The method of claim 1, wherein the service provision device comprises a charging post for electric vehicles, and
wherein the service is electrically charging the electric vehicle or an added value service.

9. The method of claim 1, wherein the service provision device is configured as a rental vehicle, and
wherein the service is renting out the rental vehicle.

10. The method of claim 1, wherein a communication between the customer and the service provision device with regard to authenticating, requesting, or authenticating and requesting the service takes place via a cable connection, a wireless local area network connection, a Bluetooth connection, a near field communication connection; or a mobile radio connection.

11. The method of claim 10, wherein the communication between the customer, the service provision device, the billing center, or a combination thereof is encrypted by a security protocol of Secure Sockets Layer, Transport Layer Security, and Internet Protocol Security.

12. The method of claim 1, wherein the billing of the requested service at the billing center is implemented with a prepaid method, a method for payment by a mobile terminal, or a debit method.

13. The method of claim 1, wherein the specific customer group is assigned to a specific performance range, a specific tariff option, or the specific performance range and the specific tariff option at a service provider that provides the service.

14. A device for authenticating a customer for a service to be provided by a service provision device, the device comprising:
a processor configured to:
authenticate a customer as member of a specific customer group on the service provision device using a first group signature assigned to the specific customer group to verify authorization of the customer to utilize a service;
request the service at the service provision device on the part of the authenticated customer; and
authenticate the customer as member of the specific customer group using a second group signature assigned to the specific customer group to verify consent of the customer to a billing process for billing the requested service at the billing center.

15. A service provision device comprising:
a device for authenticating a customer for a service to be provided by a service provision device, the device comprising:
a processor configured to:
authenticate a customer as member of a specific customer group on the service provision device using a first group signature assigned to the specific customer group to verify authorization of the customer to utilize a service;
request the service at the service provision device on the part of the authenticated customer; and
authenticate the customer as member of the specific customer group using a second group signature assigned to the specific customer group to verify consent of the customer to a billing process for billing the requested service at the billing center.
